(19) United States
(12) Patent Application Publication
(10) Pub. No.: US 2014/0215483 A1
(43) Pub. Date: Jul. 31, 2014

(54) RESOURCE-USAGE TOTALIZING METHOD, AND RESOURCE-USAGE TOTALIZING DEVICE

(71) Applicant: FUJITSU LIMITED, Kawasaki-shi (JP)

(72) Inventors: Hideyuki Akimoto, Kawasaki (JP); Yuichiro Ajima, Kawasaki (JP); Kenichi Miura, Inagi (JP); Takayuki Okamoto, Kawasaki (JP); Tomoya Adachi, Kawasaki (JP); Shinji Sumimoto, Fujisawa (JP)

(73) Assignee: FUJITSU LIMITED, Kawasaki-shi (JP)

(21) Appl. No.: 14/136,429

(22) Filed: Dec. 20, 2013

(30) Foreign Application Priority Data
Jan. 31, 2013 (JP) 2013-016970

(51) Int. Cl. G06F 9/50

(52) U.S. Cl. CPC G06F 9/5016
USPC 718/104

(57) ABSTRACT

A memory allocation/free replacing unit hooks a call of a memory allocating/freeing unit. The memory allocation/free replacing unit generates information required for totalization of a dynamically used memory amount, writes the generated information to a log file, and calls the memory allocating/freeing unit to perform memory allocation and free. A totalization processing unit loads the log file and totalizes a dynamically used memory amount for each dynamic library, for each function, or for each thread.

### CROSS-REFERENCE TO RELATED APPLICATION(S)

This application is based upon and claims the benefit of priority of the prior Japanese Patent Application No. 2013-016970, filed on Jan. 31, 2013, the entire contents of which are incorporated herein by reference.

### FIELD

The embodiments discussed herein are directed to a resource-usage totalizing program, a resource-usage totalizing method, and a resource-usage totalizing device.

### BACKGROUND

Recently, computer programs become complicated and huge in order to achieve their user-friendliness and functional improvement. It is therefore almost impossible to develop a whole program from zero, and some general-purpose programs are increasingly grouped into a library. In other words, software developers can efficiently develop a complicated and huge program using libraries.

Upon development of programs and libraries, hardware-resource usage-conscious programming is necessary to effectively use hardware resources such as memory. Therefore, a technology for providing information on usage of hardware resources is being developed.

For example, most operating systems are capable of measuring and displaying memory usage of a whole system and memory usage in units of process. Memories used are OS memory, program memory, buffer memory, cache memory, shared memory, and the like, and part of the memory used can be separately displayed in some commands or totalization.

A technology is disclosed in which a memory-usage information table used to record a usage of a system shared area that is commonly used by a plurality of subsystems, for each subsystem, is provided and this allows output of contents of the memory-usage information table (see, for example, Japanese Laid-open Patent Publication No. 01-33642). A technology is disclosed in which a memory-use status profile is generated based on a size of usable memory from a memory pool and the generated memory-use status profile is used to predict whether an out-of-memory exception is likely to occur (see, for example, Japanese Laid-open Patent Publication No. 2007-157131). In addition, a technology is disclosed in which a use status of a memory area can be checked from an application program in order to prevent such an unanticipated situation that memory allocation becomes impossible (see, for example, Japanese Laid-open Patent Publication No. 2001-265650).

However, in development of libraries, a library does not operate alone as a program, and therefore a test program or the like for calling a library is used to conduct a test or evaluation. Because of this, it is difficult to figure out hardware resource usage of a single library. In development of any software other than libraries, it is also difficult for software developers to learn hardware resource usage for each library. For example, software developers can figure out memory usage in units of process corresponding to an overall system or to a test program, but cannot figure out memory usage in units of library.

If all of a source program is opened and is re-compilable, it is not impossible to classify memory usage for each library and totalizes memory usages by making a modification to the source program. For example, by making a modification for checking a memory-usage library and a function name to the source program around a dynamic memory allocation and free function, the totalization becomes possible. However, if there are many dynamic memory allocation and free functions, then a lot of work is required to modify every part of the source program. Moreover, if there is any error in a library and a function name or if there is omission of correction therein, then the memory usage cannot be calculated correctly. In addition, if a commercially available program or library is included in a source program, then software developers cannot modify the source program because the source program is generally not opened, and are therefore practically unable to measure and totalize the memory usage.

### SUMMARY

According to an aspect of an embodiment, a computer-readable storage medium stores a resource-usage totalizing program. The resource-usage totalizing program causes a computer to execute a processing including totalizing, for a resource used when the computer executes a program, usage of the resource in units of processing smaller than a process being units of processing in which the computer executes the program, and outputting the totalized usage of the resource in the units of processing smaller than the process.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a diagram for explaining a normal call relationship between a program and a dynamic library;

FIG. 1B is a diagram for explaining a call relationship between a program and a dynamic library when a hook library is used;

FIG. 2 is a diagram of a functional configuration of a memory-usage totalizing device according to a first embodiment;

FIG. 3 is a diagram of an example of stack information;

FIG. 4 is a diagram of an example of a log file;

FIG. 5 is a diagram of an example of items stored by a totalized-information storage unit for each dynamic library;

FIG. 6 is a flowchart of a procedure of malloc_hook;

FIG. 7 is a flowchart of a procedure of free_hook;

FIG. 8 is a flowchart of a procedure of a totalization process performed by a totalization processing unit;

FIG. 9 is a flowchart of a procedure of a totalization process performed by the totalization processing unit for each call of library;

FIG. 10 is a flowchart of a procedure of a totalization process performed by the totalization processing unit at each given time interval;

FIG. 11 is a diagram of a functional configuration of a memory-usage totalizing device according to a second embodiment;

FIG. 12 is a diagram of an example of a size table;

FIG. 13 is a diagram for explaining an overview of a totalization process and a result display process performed by the memory-usage totalizing device;

FIG. 14 is a flowchart of a procedure of malloc_hook;

FIG. 15 is a flowchart of a procedure of realloc_hook;

FIG. 16 is a flowchart of a procedure of free_hook;

FIG. 17 is a flowchart of a procedure of the totalization process performed by the memory-usage totalizing device;

FIG. 18 is a diagram for explaining a method of capable of outputting a totalization result upon termination of the program due to detection of various signals; and

FIG. 19 is a functional block diagram of a computer that executes a memory-usage totalizing program according to the present embodiment.

### DESCRIPTION OF EMBODIMENT(S)

Preferred embodiments of the present invention will be explained with reference to accompanying drawings. A first embodiment describes a case of totalizing memory usage off-line, and a second embodiment describes a case of totalizing memory usage on-line. The off-line mentioned here is a method of outputting stack information on dynamic memory allocation and free as a log file, analyzing the memory usage based on the log file after end of a measured program, and displaying an analysis result. On the other hand, the on-line mentioned here is a method of performing a sequential totalization process during execution of the measured program and displaying a totalization result in response to the end of the measured program. The embodiments do not limit the disclosed technology.

### [a] First Embodiment

First of all, the terms used in the present application are explained.

Program: Instructions (processes) written to be carried out by a computer. The program can be classified as a system program and an application program. In the present application, however, the program indicates an application program.

Process: An executable unit when a computer executes a program and an executable unit of a program managed by an operating system (OS). A plurality of executable units (threads) are allocated in one process, and their execution rights are scheduled, but a unit of an execution program or a resource is one. The program refers to a source code or a state in which the program is stored in an auxiliary storage device (hard disk drive etc.), while the process refers to a running program on a computer.

Dynamic memory: A method of dynamically allocating a memory area where data is stored during program execution, or allocated memory. The program is capable of requesting allocation of memory when memory is needed and is capable of freeing (deallocating, releasing) the memory when it becomes unnecessary. OS allocates an unused memory area of a requested size from a heap area according to the request.

A malloc system function: Function called by a program when dynamic memory is allocated or freed.

void*malloc(size_t size): Memory specified by size is dynamically allocated, and its starting address is returned. size_t represents a size type and void* represents a pointer type.

void*realloc(void*ptr, size_t size): Dynamic memory indicated by ptr is freed, memory specified by size is dynamically allocated, and its starting address is returned. Memory contents before enlargement or reduction are copied to a new area. When the area is enlarged, the memory contents of an enlarged portion are undefined.

void*free(void*ptr): Dynamic memory indicated by ptr is freed.

void*memalign(size_t alignment, size_t size): Memory specified by size is dynamically allocated, and its starting address is returned. The starting address is multiples of alignment. The alignment should be a power of two.

A background technology of the present application is explained below. Linux™ C language generally has the following four memory areas. The target of totalization of memory usages according to the present application is 4. heap area (dynamic memory).

1. Program area: Area where program codes are placed.
2. Static area: Area where external variables and static variables are placed.
3. Stack area: Area where automatic variables, arguments of functions, return values, and the like are placed (tens of MB).
4. Heap area: Area used by the dynamic memory allocation and free functions (several GB).

Most of modern computers are stored-program computers and stack-based computers in which temporary information is stored in a stack. The stack-based computer stores information for a function during execution in a stack (call stack) each time the function is called. A stack is composed of stack frames and although its structure is dependent on architecture, the following information is stored.

Return address

Local data

Augment to be passed

Others

By analyzing stack information for a specific function, a function call history reaching the specific function, information on the augments, and the like can be obtained. The history information includes a program name and a dynamic library name in which the function is stored. The dynamic library mentioned here is a library called and executed upon execution of the program without connecting a library code to a program used to call the library.

If there are function symbols of the same name as each other in a plurality of dynamic libraries, a linker has a characteristic to use an initially found symbol (in a case of Linux™). Therefore, a developer re-defines the dynamic memory allocation function and free function included in a standard function, and causes the linker to load them before a standard library (LD_PRELOAD environment variable is used), and can thereby replace the standard library. This method is called “hook of a function”, which is used to obtain trace information for debug and quality improvement in program development.

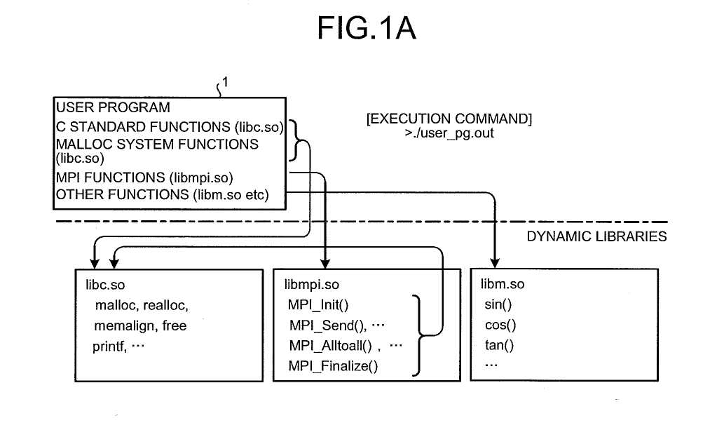

A call relationship between a program and a dynamic library is explained below. FIG. 1A is a diagram for explaining a normal call relationship between a program and a dynamic library, and FIG. 1B is a diagram for explaining a call relationship between a program and a dynamic library when a hook library is used. The hook library mentioned here is a library to hook (preempt) a call of a library.

As illustrated in FIG. 1A, a user program 1 performs processes while calling c standard functions, malloc system functions, Messaging Passing Interface (MPI) functions, and other functions. The MPI functions mentioned here are functions for use when performing communication between computation nodes in a parallel computer.

As illustrated in FIG. 1A, when the user program 1 is executed by an execution command “./user_pg.out” and the user program 1 calls a c standard function and a malloc system function, a corresponding function in a dynamic library libc.so is executed. When the user program 1 calls an MPI function, a corresponding function in a dynamic library libmpi.so is executed, and when the user program 1 calls an other function, a corresponding function in a dynamic library libm.so is executed.

On the other hand, as illustrated in FIG. 1B, if a hook library libmallochook.so is used, and when the user program 1 calls the malloc system function, a corresponding function in the hook library libmallochook.so is executed instead of the dynamic library libc.so. That is, when the user program 1 calls the malloc system function, the dynamic library libc.so is hooked by the hook library libmallochook.so. Then the function in the hook library performs the totalization process of the memory usage and calls the corresponding function in the dynamic library libc.so.

In this way, the hook library libmallochook.so hooks the execution of the malloc system function from the dynamic library libc.so, and can thereby perform the totalization process of the memory usage. The user can specify a use of the hook library libmallochook.so by the execution command “LD_PRELOAD=./libmallochook.so ./user_pg.out”. The hook library libmallochook.so is preloaded before the standard library libc.so by the execution command, and the hooking is performed by the hook library libmallochook.so.

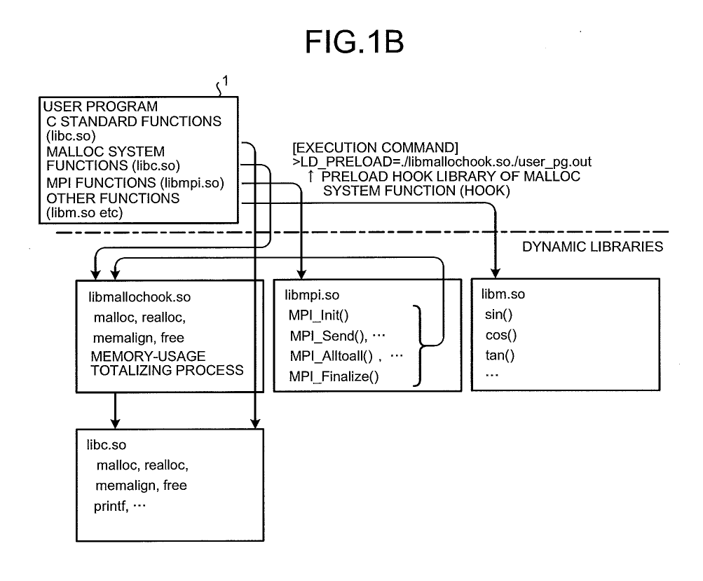

A functional configuration of a memory-usage totalizing device according to the first embodiment will be explained below. FIG. 2 is a diagram of the functional configuration of a memory-usage totalizing device according to the first embodiment. As illustrated in FIG. 2, a memory-usage totalizing device 10 includes a measured unit 100, a totalization processing unit 200, and a log file 300.

The memory-usage totalizing device 10 is implemented by the computer executing a memory-usage totalizing program. The measured unit 100 is implemented by the computer executing the measured program, and the totalization processing unit 200 is implemented by the computer executing a totalization processing program. In other words, the memory-usage totalizing program includes the measured program and the totalization processing program.

The measured unit 100 is a target whose memory usage is totalized, and outputs information required for totalization to the log file 300. The totalization processing unit 200 loads the log information from the log file 300, totalizes memory usage for each dynamic library, each function, or each thread, and outputs the totalized memory usage. For which of each dynamic library, each function, and each thread the memory usage is totalized is specified as a parameter when the measured program is executed.

The measured unit 100 includes an application processing unit 110, a memory allocation/free replacing unit 120, and a memory allocating/freeing unit 130. The application processing unit 110 executes a process for a target whose memory usage is totalized.

The memory allocation/free replacing unit 120 hooks a call of the memory allocating/freeing unit 130. The memory allocation/free replacing unit 120 then generates information required for totalizing memory usage, outputs the generated information to the log file 300, and calls the memory allocating/freeing unit 130 to perform memory allocation and free. The memory allocation/free replacing unit 120 includes an initialization unit 121, a memory allocated/freed amount checking unit 122, a sorting-information acquiring unit 123, a memory allocation/free calling unit 124, and a log-information output unit 125.

The initialization unit 121 performs an initialization process for a memory allocation and free process while generating log information, and performs, for example, an initial setting of variables. The memory allocated/freed amount checking unit 122 checks a memory allocated amount and checks a pointer to an area where the memory is freed.

The sorting-information acquiring unit 123 acquires a thread ID when memory usage is totalized for each thread ID, and acquires stack information when memory usage is totalized for each library or for each function. When a function of a dynamic library is called, information for the dynamic library and the function is stacked in the stack. Therefore, when the malloc system function is called, by acquiring the stack information, the memory allocation/free replacing unit 120 can acquire information for a sequence of the functions that call the malloc system function.

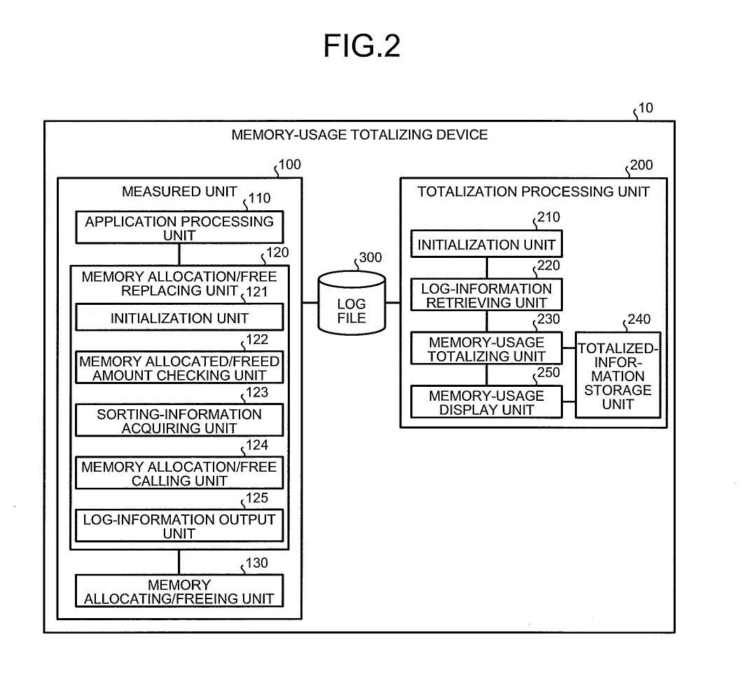

FIG. 3 is a diagram of an example of stack information. As illustrated in FIG. 3, eight elements are stacked. An element “7” and an element “6” are information to be always stacked when a program is executed. An element “5” indicates a call of a main function. Functions func_{—}0, func_a0, func_a1, func_b0, and malloc_hook from the element “5” toward an element “0” are sequentially called. The function of the dynamic library initially called by the main function is func_a0 in liba.so in an element “3”, and the function finally calling a malloc function is func_b0 in libb.so. FIG. 3 depicts an example of the case where the backtrace_symbols function in Linux traces back and translates the information in the stack.

When memory usage is totalized for each dynamic library or for each function, the totalization processing unit 200 can totalize memory usage for each dynamic library or for each function initially called from the main, and can also totalize memory usage for each dynamic library or for each function finally calling the malloc system function. Moreover, the totalization processing unit 200 can totalize the memory usages of all the dynamic libraries or all the functions from the one initially called from the main to the one finally calling the malloc system function, for each dynamic library or for each function. Which of the methods is used to totalize them for each dynamic library or for each function is specified as a parameter when the measured program is executed.

The memory allocation/free calling unit 124 calls the memory allocating/freeing unit 130, and performs memory allocation and memory free. The log-information output unit 125 outputs a function name, a memory amount allocated or freed, and a pointer to a memory area allocated or freed to the log file 300 with the thread ID or with the stack information.

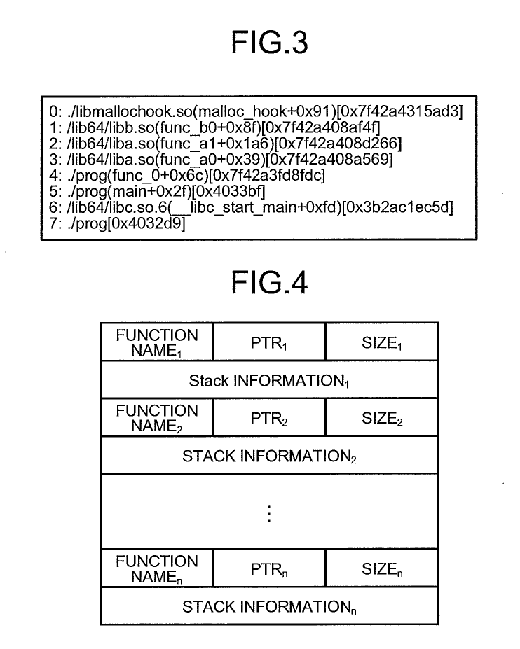

FIG. 4 is a diagram of an example of the log file 300. As illustrated in FIG. 4, the log file 300 stores therein function nameᵢ, ptrᵢ, sizeᵢ, and stack informationᵢ for each called malloc system function (1≦i≦n). The ptrᵢ is a pointer to an allocated or a freed memory area, and the sizeᵢ is an allocated or a freed memory amount. FIG. 4 depicts a case of totalizing memory usage for each dynamic library or for each function. However, if a memory amount is totalized for each thread, the thread ID is stored therein instead of the stack informationᵢ.

Referring back to FIG. 2, the memory allocating/freeing unit 130 performs memory allocation from the heap area and memory free to the heap area. The memory allocation/free replacing unit 120 corresponds to the libmallochook.so illustrated in FIG. 1B, and the memory allocating/freeing unit 130 corresponds to the libc.so illustrated in FIG. 1B.

The totalization processing unit 200 includes an initialization unit 210, a log-information retrieving unit 220, a memory-usage totalizing unit 230, a totalized-information storage unit 240, and a memory-usage display unit 250. The initialization unit 210 performs an initialization process for a totalization process, and performs, for example, an initial setting of variables. The log-information retrieving unit 220 retrieves log information from the log file 300.

The memory-usage totalizing unit 230 uses the log information retrieved by the log-information retrieving unit 220 to totalize memory usage for each dynamic library, for each function, or for each thread.

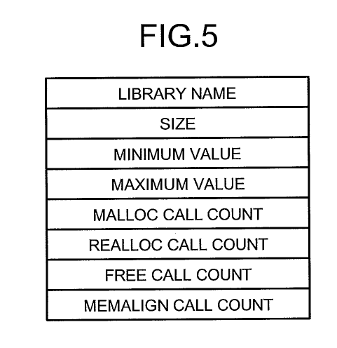

The totalized-information storage unit 240 stores therein memory usages totalized by the memory-usage totalizing unit 230. FIG. 5 is a diagram of an example of items stored in the totalized-information storage unit 240 for each dynamic library. As illustrated in FIG. 5, the totalized-information storage unit 240 stores therein library name, size, minimum value, maximum value, malloc call count, realloc call count, free call count, and memalign call count for each dynamic library.

The library name is a name of a dynamic library whose memory usage is totalized, and the size is the totalized memory usage. A memory amount allocated is added to the size, and a memory amount freed is subtracted from the size.

The maximum value is a maximum value of a memory amount allocated at a time point during allocation and free, and the minimum value is a minimum value of a memory amount allocated at a time point during allocation and free. For example, in the function of performing an initialization process among all processes, the memory is mainly allocated, and therefore the maximum value becomes a large positive value as compared with the other functions. On the other hand, in the function of performing an end process among all the processes, the memory is mainly freed, and therefore the minimum value becomes a large negative value as compared with the other functions.

The malloc call count is the number of malloc-function calls, the realloc call count is the number of realloc-function calls, the free call count is the number of free-function calls, and the memalign call count is the number of memalign-function calls.

The totalized-information storage unit 240 stores therein a function name instead of a library name when memory usage is totalized for each function and stores therein a thread ID instead of a library name when memory usage is totalized for each thread.

The memory-usage display unit 250 outputs totalized information stored in the totalized-information storage unit 240 to a display device. The memory-usage display unit 250 can also output totalized information to other devices such as a printer and a storage device.

A procedure of the memory allocation/free replacing unit 120 will be explained below using the malloc_hook and the free_hook as examples. The malloc_hook mentioned here is malloc in the dynamic library libmallochook.so illustrated in FIG. 1B, and the free_hook mentioned here is free in the dynamic library libmallochook.so illustrated in FIG. 1B.

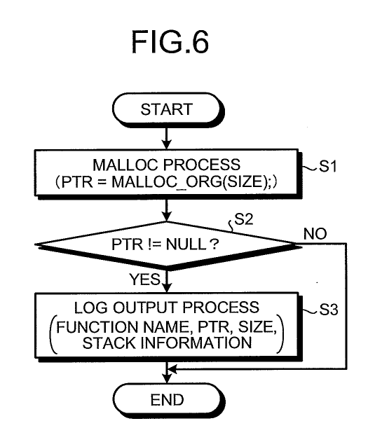

FIG. 6 is a flowchart of a procedure of the malloc_hook. As illustrated in FIG. 6, the malloc_hook performs a malloc process (Step S1). That is, the malloc_hook calls malloc_org(size), and sets a call result in the ptr. The malloc_org mentioned here is malloc in the libc.so as illustrated in FIG. 1B, and the size is a memory amount for requiring allocation.

Then, the malloc_hook determines whether the ptr is not NULL (Step S2). When the ptr is NULL, then the malloc_hook ends the process, and when the ptr is not NULL, the memory is allocated, and therefore the malloc_hook performs a log output process (Step S3). Specifically, the malloc_hook outputs, as the log output process, the function name, the ptr, the size, and the stack information to the log file 300. The function name herein is “malloc”, and the stack information is a result of the translation using the backtrace_symbols. The malloc_hook then ends the process.

In this way, the malloc_hook hooks the call of the malloc and outputs the information required for totalizing memory usage to the log file 300, and the totalization processing unit 200 can thereby totalize the memory usage. The realloc_hook and a memalign_hook perform the same process as that of the malloc_hook except that realloc_org(prev_ptr, size) and memalign_org(size) are called respectively instead of the malloc_org(size) at Step S1.

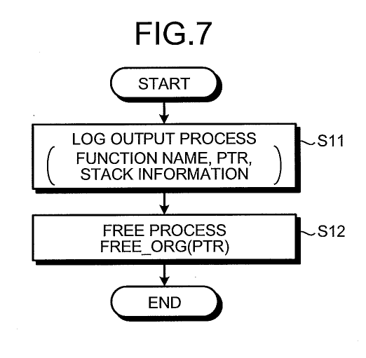

FIG. 7 is a flowchart of a procedure of the free_hook. As illustrated in FIG. 7, the free_hook performs a log output process on a free area specified by the ptr (Step S11). Specifically, the free_hook outputs, as the log output process, the function name, the ptr, and the stack information to the log file 300. The function name herein is “free”, and the stack information is a result of the translation using the backtrace_symbols. The ptr is given as argument for specifying a free area when the free_hook is called.

The free_hook performs a free process (Step S12). That is, the free_hook calls free_org(ptr). The free_org herein is free in the libc.so illustrated in FIG. 1B. The free_hook then ends the process.

In this way, the free_hook hooks the call of the free and outputs the information required for totalizing memory usage to the log file 300, and the totalization processing unit 200 can thereby totalize the memory usage.

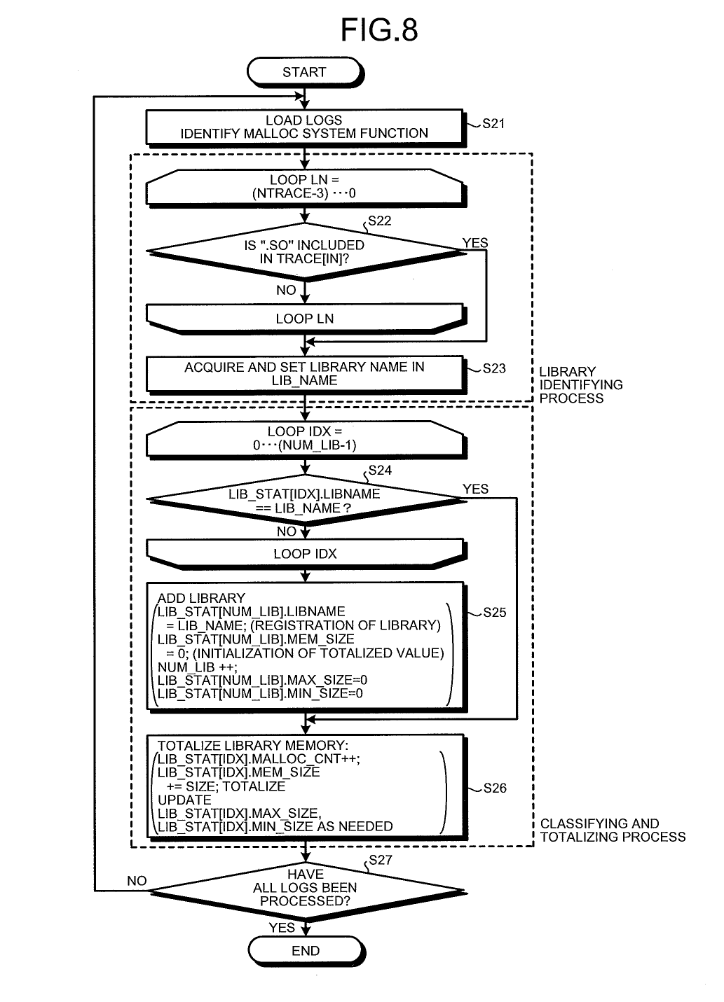

A procedure of a totalization process performed by the totalization processing unit 200 will be explained below. FIG. 8 is a flowchart of a procedure of the totalization process performed by the totalization processing unit 200. As illustrated in FIG. 8, the totalization processing unit 200 loads logs from the log file 300 to identify a malloc system function (Step S21).

The totalization processing unit 200 then determines whether “.so” is included in trace[ln] (Step S22). Here, “loop ln=(ntrace-3) . . . 0” and “loop ln” indicate a loop process that repeats a process between the two “loop ln” while sequentially changing “ln” from (ntrace-3) to 0. The trace[ln] represents each element in the stack information illustrated in FIG. 3, and the ntrace represents number of elements-1 of the stack information. In the example of FIG. 3, ntrace=7, and trace[ntrace-3] indicates element “4”. In other words, at Step S22, when searching stack information in the order of functions being called to retrieve a library name, then the totalization processing unit 200 exits the loop.

The totalization processing unit 200 sets a name of the retrieved library in lib_name (Step S23). That is, the totalization processing unit 200 identifies the dynamic library initially called from the main function by the processes at Step S22 and Step S23.

The totalization processing unit 200 then determines whether the name of the identified dynamic library has been registered in lib_stat (Step S24). The lib_stat is a structure corresponding to the totalized-information storage unit 240, and lib_stat[idx].libname indicates an idx-th library name stored in the totalized-information storage unit 240. In other words, the totalization processing unit 200 sequentially changes the idx from 0 to num_lib−1, and determines whether the name of the identified dynamic library has been registered in the totalized-information storage unit 240. The num_lib is the number of dynamic libraries stored in the totalized-information storage unit 240.

When the name of the identified dynamic library has been registered in the lib_stat, the totalization processing unit 200 proceeds to Step S26, and adds the library when the name of the identified dynamic library has not been registered in the lib_stat (Step S25).

Specifically, the totalization processing unit 200 registers the library name, as a library addition process, using libstat[num_lib].libname=lib_name, initializes the totalized value to “0” using lib_stat[num_lib].mem_size=0, and adds “1” to the num_lib using num_lib++. In addition, the totalization processing unit 200 initializes the maximum value and the minimum value to “0” using lib_stat[num_lib].max_size=0 and lib_stat[num_lib].min_size=0 respectively. The mem_size, the max_size, and the min_size correspond to Size, Maximum value, and Minimum value of FIG. 5, respectively.

The totalization processing unit 200 totalizes the memory amount used by the dynamic library (Step S26). Specifically, the totalization processing unit 200 adds “1” to the malloc call count malloc_cnt using lib_stat[idx].malloc_cnt++, and adds the allocated memory amount to the size mem_size using lib_stat[idx].mem_size+=size. In addition, the totalization processing unit 200 updates lib_stat[idx].max_size and lib_stat[idx].min_size as needed. In other words, the totalization processing unit 200 performs a classifying and totalizing process of classifying the used memory amount by the dynamic library and totalizing the used memory amounts through Step S24 to Step S26.

The case where the identified malloc system function is the malloc is represented herein. However, if the identified function is the realloc, the free, and the memalign, then “1” is added to the realloc call count, the free call count, and to the memalign call count. If the identified function is the free, then the size is a value obtained by multiplying a freed amount by “−1”.

The totalization processing unit 200 determines whether all the logs have been processed (Step S27). When all the logs have been prcessed, the totalization processing unit 200 ends the totalization process, and when there is any log which is not processed, the totalization processing unit 200 returns to Step S21, and identifies a next malloc system function.

In this way, the totalization processing unit 200 totalizes memory usage using the log file 300 separately from execution of the measured program, and the memory-usage totalizing device 10 can thereby totalize memory usage off-line.

The totalization processing unit 200 totalizes the memory usage for each dynamic library; however, the totalization processing unit 200 identifies a called function name instead of the library name and registers the function name instead of the library name in the totalized-information storage unit 240, which enables the memory usage to be totalized for each function. In addition, the totalization processing unit 200 registers the thread ID instead of the library name in the totalized-information storage unit 240, which enables the memory usage to be totalized for each thread.

The totalization processing unit 200 sequentially changes “ln” from (ntrace-3) to 0 when the library is identified at Step S22. However, by sequentially changing ln from 0 to (ntrace-3), the totalization processing unit 200 can identify the dynamic library that finally calls the malloc system function. In other words, the totalization processing unit 200 can also totalize the memory usage for each library that finally calls the malloc system function. Furthermore, the totalization processing unit 200 identifies a plurality of dynamic libraries for each call of one malloc system function, and can totalize memory usages for the dynamic libraries from the call of the main function to the call of the malloc system function.

The totalization processing unit 200 totalizes, when the same dynamic library is called a plurality of times, all the memory amounts used for the calls. However, when a dynamic library is called a plurality of times, the totalization processing unit 200 can also totalize the memory amount used for each call. Therefore, a procedure of the totalization process performed by the totalization processing unit 200 for each call of library will be explained below.

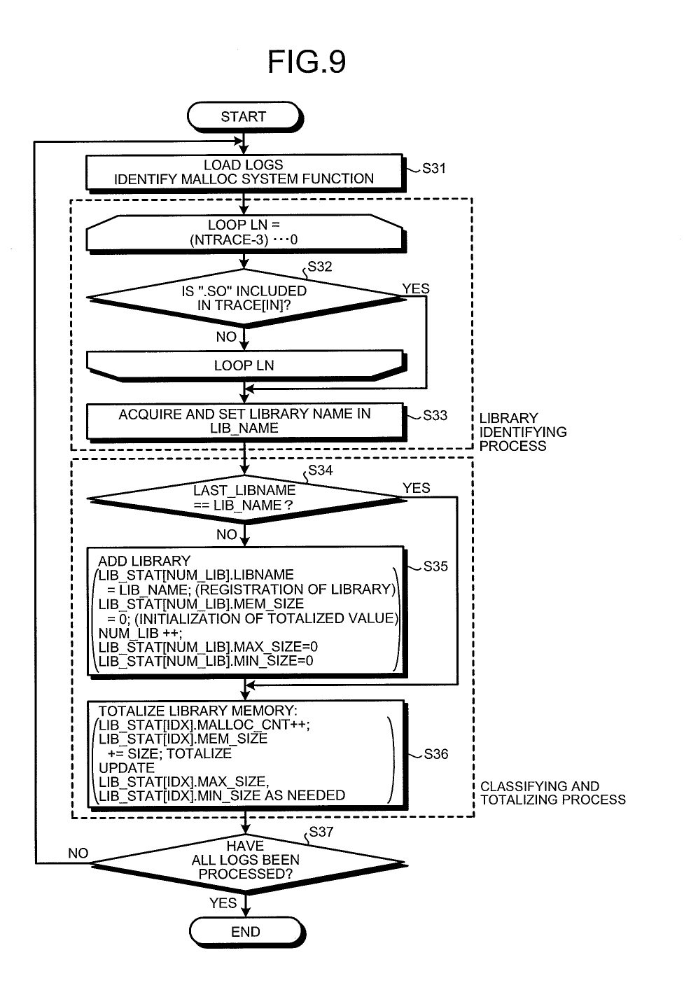

FIG. 9 is a flowchart of a procedure of the totalization process performed by the totalization processing unit 200 for each call of library. As illustrated in FIG. 9, the totalization processing unit 200 loads logs from the log file 300 to identify a malloc system function (Step S31).

The totalization processing unit 200 then sequentially changes ln from (ntrace-3) to 0 to determine whether “.so” is included in the trace[ln] (Step S32). In other words, when searching the stack information in the order of functions being called to retrieve a library name, then the totalization processing unit 200 exits the loop.

The totalization processing unit 200 sets a name of the retrieved library in the lib_name (Step S33). That is, the totalization processing unit 200 identifies the dynamic library initially called from the main function by the processes at Step S32 and Step S33.

The totalization processing unit 200 then determines whether the name of the identified dynamic library is a name last_libname of the dynamic library identified when the malloc system function is called last time (Step S34).

When the name of the identified dynamic library is the name of the dynamic library identified when the malloc system function is called last time, the name of the dynamic library has been registered, and therefore the totalization processing unit 200 proceeds to Step S36. On the other hand, when the name of the identified dynamic library is not the name of the dynamic library identified when the malloc system function is called last time, the totalization processing unit 200 adds the library (Step S35). Specifically, the totalization processing unit 200 registers the library name, as the library addition process, using the lib_stat[num_lib].libname=lib_name, initializes the totalized value to “0” using the lib_stat[num_lib].mem_size=0, and adds “1” to the num_lib using the num_lib++. In addition, the totalization processing unit 200 initializes the maximum value and the minimum value to “0” using the lib_stat[num_lib].max_size=0 and the lib_stat[num_lib].min_size=0 respectively.

The totalization processing unit 200 totalizes the memory amount used by the dynamic library (Step S36). Specifically, the totalization processing unit 200 adds “1” to the malloc call count malloc_cnt using the lib_stat[idx].malloc_cnt++, and adds the allocated memory amount to the size mem_size using the lib_stat[idx].mem_size+=size. In addition, the totalization processing unit 200 updates the lib_stat[idx].max_size and the lib_stat[idx].min_size as needed. In other words, the totalization processing unit 200 performs the classifying and totalizing process of classifying the used memory amount by each call of dynamic libraries and totalizing the used memory amounts through Step S34 to Step S36.

The case where the identified malloc system function is the malloc is represented herein. However, if the identified function is the realloc, the free, and the memalign, then “1” is added to the realloc call count, the free call count, and to the memalign call count. If the identified function is the free, then the size is a value obtained by multiplying a freed amount by “−1”.

The totalization processing unit 200 determines whether all the logs have been processed (Step S37). When all the logs have been processed, the totalization processing unit 200 ends the totalization process, and when there is any log which is not processed, the totalization processing unit 200 returns to Step S31, and identifies a next malloc system function.

In this way, when the same dynamic library is called a plurality of times, the totalization processing unit 200 totalizes a memory amount used for each call and can thereby calculate a memory amount used by one call of the dynamic library.

The totalization processing unit 200 can also totalize memory usage at each given time interval. Therefore, a procedure of a totalization process performed by the totalization processing unit 200 at each given time interval will be explained below.

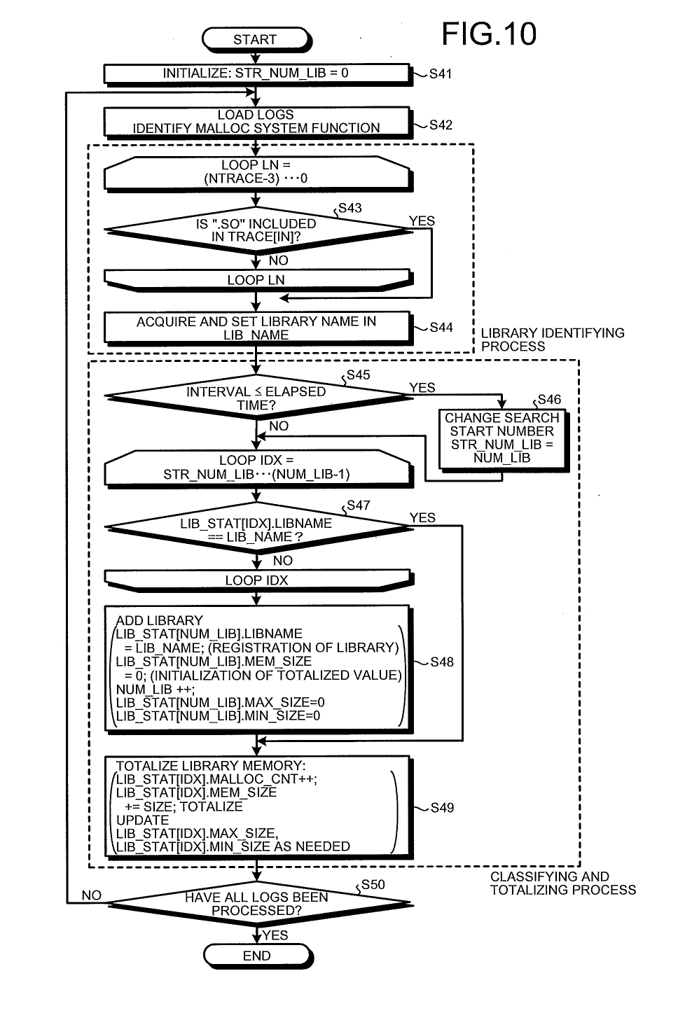

FIG. 10 is a flowchart of a procedure of the totalization process performed by the totalization processing unit at each given time interval. As illustrated in FIG. 10, the totalization processing unit 200 initializes str_num_lib to “0” (Step S41). The str_num_lib mentioned here represents a search start number for index idx of the totalized-information storage unit 240 set at each given time interval. In other words, the totalized-information storage unit 240 is divided into a plurality of blocks used at each given time interval, and a first of search start numbers.

The totalization processing unit 200 loads logs from the log file 300 to identify a malloc system function (Step S42). The totalization processing unit 200 then determines whether “.so” is included in the trace[ln] (Step S43).

The totalization processing unit 200 sets a name of a retrieved library in the lib_name (Step S44). That is, the totalization processing unit 200 identifies the dynamic library initially called from the main function by the processes at Step S42 and Step S43.

The totalization processing unit 200 then determines whether an elapsed time is the interval or more, that is, whether a given time has elapsed (Step S45). When the elapsed time is the interval or more, the given time has elapsed, and therefore the totalization processing unit 200 sets the num_lib in the str_num_lib (Step S46). In other words, the totalization processing unit 200 starts using the next block of the totalized-information storage unit 240.

The totalization processing unit 200 then determines whether the name of the identified dynamic library has been registered in the lib_stat (Step S47). That is, the totalization processing unit 200 sequentially changes the idx from the str_num_lib to the num_lib−1, and determines whether the name of the identified dynamic library has been registered in a current block of the totalized-information storage unit 240. The num_lib is the number of libraries stored in the totalized-information storage unit 240 over all the blocks.

When the name of the identified dynamic library has been registered in the current block of the lib_stat, the totalization processing unit 200 proceeds to Step S49. On the other hand, when the name of the identified dynamic library has not been registered in the current block of the lib_stat, the totalization processing unit 200 adds the library (Step S48). Specifically, the totalization processing unit 200 registers the library name, as the library addition process, using the lib_stat[num_lib].libname=lib_name, initializes the totalized value to “0” using the lib_stat[num_lib].mem_size=0, and adds “1” to the num_lib using the num_lib++. In addition, the totalization processing unit 200 initializes the maximum value and the minimum value to “0” using the lib_stat[num_lib].max_size=0 and the lib_stat[num_lib].min_size=0 respectively.

The totalization processing unit 200 totalizes the memory amount used by the dynamic library (Step S49). Specifically, the totalization processing unit 200 adds “1” to the malloc call count malloc_cnt using the lib_stat[idx].malloc_cnt++, and adds the allocated memory amount to the size mem_size using the lib_stat[idx].mem_size+=size. In addition, the totalization processing unit 200 updates the lib_stat[idx].max_size and the lib_stat[idx].min_size as needed. In other words, the totalization processing unit 200 performs a classifying and totalizing process of classifying the used memory amount by the dynamic library for each block and totalizing the used memory amounts through Step S45 to Step S49.

The case where the identified malloc system function is the malloc is represented herein. However, if the identified function is the realloc, the free, and the memalign, then “1” is added to the realloc call count, the free call count, and to the memalign call count. If the identified function is the free, then the size is a value obtained by multiplying a freed amount by “−1”.

The totalization processing unit 200 determines whether all the logs have been processed (Step S50). When all the logs have been processed, the totalization processing unit 200 ends the totalization process, and when there is any log which is not rocessed, the totalization processing unit 200 returns to Step S42, and identifies a next malloc system function.

In this way, the totalization processing unit 200 totalizes memory usage at each given time interval, and the memory-usage totalizing device 10 can thereby collect the information on the change with time of the memory usage.

As explained above, the first embodiment is configured that the memory allocation/free replacing unit 120 hooks the call of the memory allocating/freeing unit 130. The memory allocation/free replacing unit 120 then generates information required for totalizing a dynamically used memory amount, writes the generated information to the log file 300, and calls the memory allocating/freeing unit 130 to perform memory allocation and free. The totalization processing unit 200 loads the log file 300 and totalizes the dynamically used memory amount off-line for each dynamic library, for each function, or for each thread.

Therefore, in the development of dynamic libraries, developers can figure out the dynamically used memory amount for each dynamic library, for each function, or for each thread without changing the dynamic library, and can also obtain information useful for reduction of the memory usage. Even if there occurs an abnormal end unexpected by the developers, because the logs up to that point are stored, it is possible to totalize the memory usage up to that point. Moreover, different totalization can be performed based on the result of measurement performed once.

In the first embodiment, the totalization processing unit 200 can also totalize the dynamically used memory amount for each call of dynamic libraries or for each call of functions included in a dynamic library. Therefore, in the development of dynamic libraries, the developers can figure out the dynamically used memory amount for each call of dynamic libraries or for each call of functions, and can obtain information useful for memory saving.

Moreover, in the first embodiment, the totalization processing unit 200 can also totalize the dynamically used memory amount for each dynamic library, for each function, or for each thread at each given time interval. Therefore, in the development of dynamic libraries, the developers can recognize the change with time of the dynamically used memory amount and can obtain information useful for memory saving.

### [b] Second Embodiment

The first embodiment has explained the case where the measured program outputs log information and the totalization processing unit 200 uses the log information to totalize the memory usage off-line. However, it is also possible to totalize the memory usage on-line while executing the measured program. Therefore, the second embodiment will explain a memory-usage totalizing device that totalizes memory usage on-line while executing a measured program.

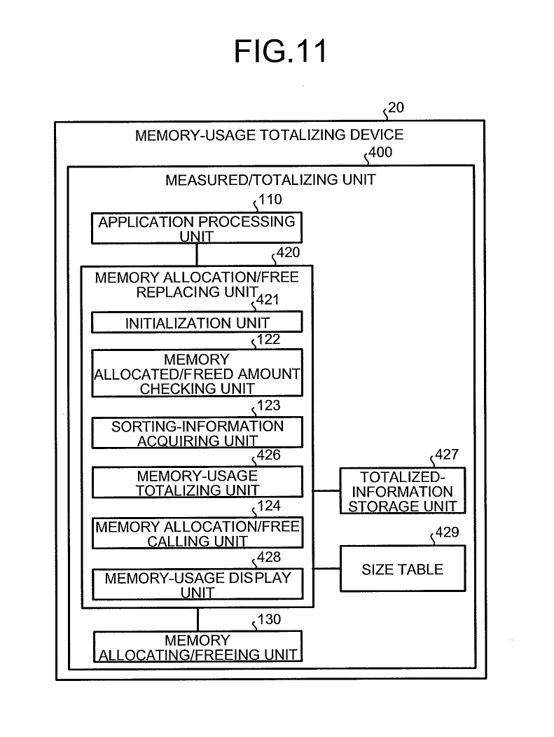

First of all, a functional configuration of the memory-usage totalizing device according to the second embodiment will be explained below. FIG. 11 is a diagram of the functional configuration of the memory-usage totalizing device according to the second embodiment. As illustrated in FIG. 11, a memory-usage totalizing device 20 includes a measured/totalizing unit 400. The measured/totalizing unit 400 is implemented by the computer executing the measured program, and is a target whose memory usage is totalized and also performs a totalization process. That is, the measured/totalizing unit 400 performs the totalization process instead of outputting information required for totalization to the log file 300.

The measured/totalizing unit 400 includes the application processing unit 110, a memory allocation/free replacing unit 420, a totalized-information storage unit 427, a size table 429, and the memory allocating/freeing unit 130. For the sake of simplicity of explanation, the same reference signs are assigned to the functioning units for serving the same roles as these of the units illustrated in FIG. 2, and detailed explanation thereof is therefore omitted.

The memory allocation/free replacing unit 420 hooks a call of the memory allocating/freeing unit 130. The memory allocation/free replacing unit 420 then totalizes memory usage and calls the memory allocating/freeing unit 130 to perform memory allocation and free. The memory allocation/free replacing unit 420 includes an initialization unit 421, the memory allocated/freed amount checking unit 122, the sorting-information acquiring unit 123, a memory-usage totalizing unit 426, the memory allocation/free calling unit 124, and a memory-usage display unit 428.

The initialization unit 421 performs an initialization process for a memory allocation and free process while totalizing memory usage, and performs, for example, an initial setting of variables. The memory-usage totalizing unit 426 uses the stack information and the totalized-information storage unit 427 to totalize dynamic memory usage. The memory-usage display unit 428 outputs totalized information stored in the totalized-information storage unit 427 to a display device. The memory-usage display unit 428 can also output the totalized information to other devices such as a printer and a storage device.

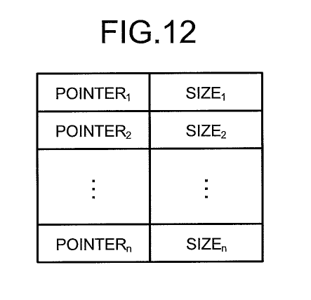

The totalized-information storage unit 427 stores therein memory usages totalized by the memory-usage totalizing unit 426. The totalized-information storage unit 427 has the same data structure as that of the totalized-information storage unit 240 illustrated in FIG. 2. The size table 429 is used to search for sizeᵢ from a pointerᵢ of a dynamically allocated memory area. FIG. 12 is a diagram of an example of the size table 429. As illustrated in FIG. 12, the size table 429 stores therein the pointerᵢ and the sizeᵢ (1≦i≦n) in association with each other.

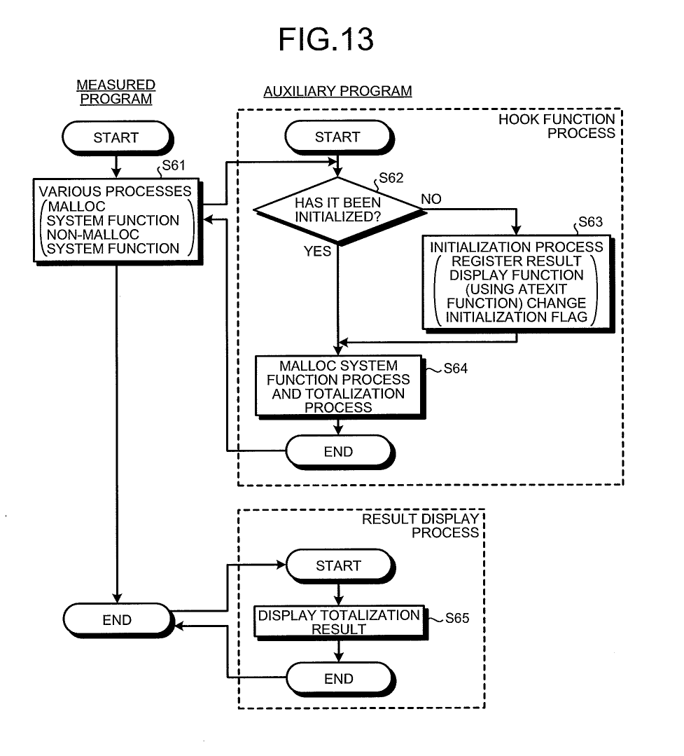

An overview of a totalization process and a result display process performed by the memory-usage totalizing device 20 will be explained below. FIG. 13 is a diagram for explaining the overview of the totalization process and the result display process performed by the memory-usage totalizing device 20.

As illustrated in FIG. 13, the memory-usage totalizing device 20 executes the measured program and performs various processes while calling a malloc system function and a non-malloc system function (Step S61). When a malloc system function is called from the measured program, the call of the malloc system function is hooked, and a hook function as an auxiliary program performs a process.

The hook function determines whether initialization has been finished using an initialization flag (Step S62). When initialization has not been finished, the hook function performs an initialization process (Step S63). Specifically, the hook function uses an atexit function to register a result display function as a function to be operated after the measured program is normally ended (including an abnormal end within a range expected by the programmer). In addition, the hook function changes the initialization flag indicating whether the initialization has been finished or not to “Initialized”. The hook function then performs a malloc system function process and a totalization process (Step S64).

When the process of the measured program is ended, the result display function registered using the atexit function is activated. The result display function then displays a totalization result (Step S65).

In this way, by operating the result display function after the measured program is normally ended, the memory-usage totalizing device 20 can display the totalization result. To display the totalization result in response to the normal end of the measured program, it is simply configured to operate a stack, operate a return address in association with the end of the main function, and change the address to an address of the function for displaying the totalization result. The return address in association with the end of the totalization-result display function is simply changed to an original return address.

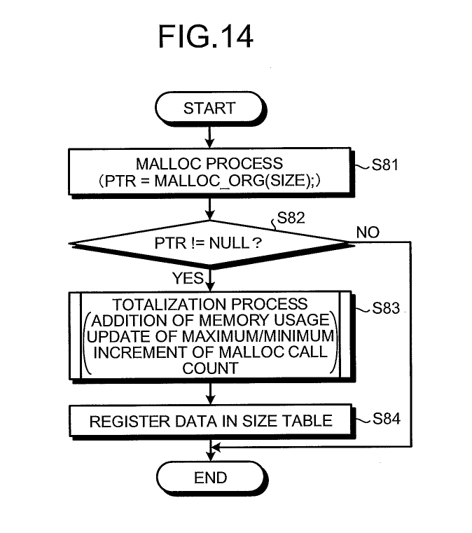

A procedure of the memory allocation/free replacing unit 420 will be explained below using the malloc_hook, the realloc_hook, and the free_hook as examples. FIG. 14 is a flowchart of the procedure of the malloc_hook.

As illustrated in FIG. 14, the malloc_hook performs a malloc process (Step S81). That is, the malloc_hook calls the malloc_org(size) and sets the call result in the ptr.

Then, the malloc_hook determines whether the ptr is not NULL (Step S82). When the ptr is NULL, then the malloc_hook ends the process, and when the ptr is not NULL, the memory is allocated, and therefore the malloc_hook performs a totalization process (Step S83). Specifically, the malloc_hook performs, as the totalization process, addition of memory usage, update of the maximum and the minimum of memory usages, and increment of the malloc call count.

The malloc_hook registers pointer (ptr) and size (size) in the size table 429 (Step S84). The malloc_hook then ends the process.

In this way, the malloc_hook hooks the call of the malloc and performs the totalization process of the memory usage, and the memory-usage totalizing device 20 can thereby totalize the memory usage on-line. At Step S81, the memalign_hook performs the same process as that of the malloc_hook except for call of the memalign_org(size) instead of the malloc_org(size).

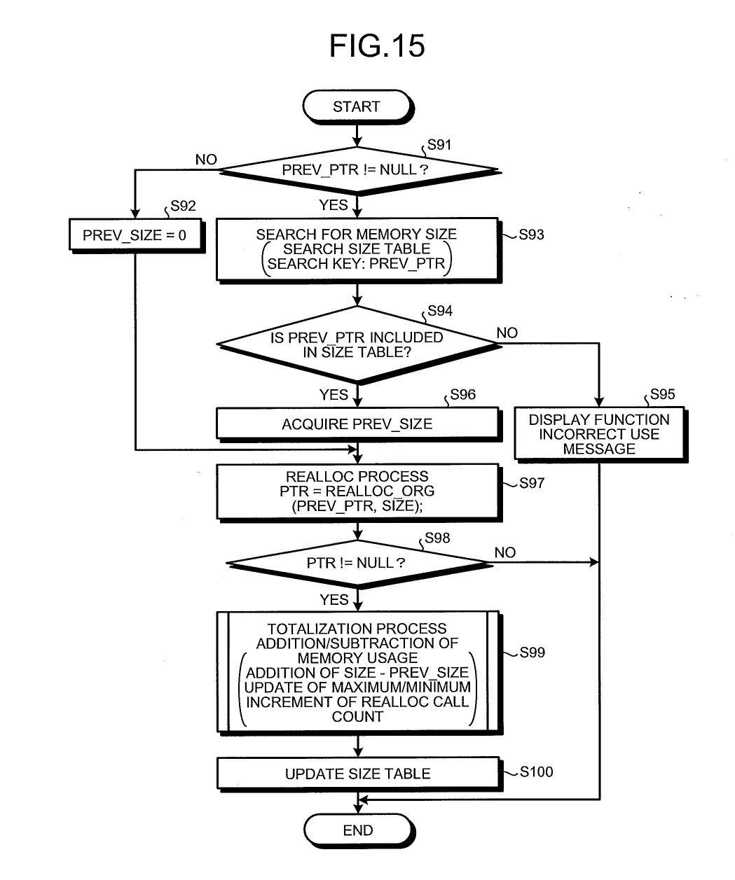

FIG. 15 is a flowchart of a procedure of realloc_hook. As illustrated in FIG. 15, the realloc_hook determines whether the prev_ptr is not NULL (Step S91). When the prev_ptr is NULL, then the realloc_hook sets “0” in prev_size (Step S92), and proceeds to Step S97. The prev_ptr mentioned here is an argument indicating a pointer to a free area upon calling of the realloc, and the prev_size mentioned here is an argument indicating a size of the free area upon calling of the realloc.

On the other hand, when the prev_ptr is not NULL, the free area is specified, and therefore the realloc_hook searches for a memory size of the free area (Step S93). That is, the realloc_hook searches the size table 429 using the prev_ptr as a search key.

Then the realloc_hook determines whether the prev_ptr is included in the size table 429 (Step S94). When the prev_ptr is not included therein, the argument is not correctly specified, and therefore the realloc_hook displays a function incorrect use message (Step S95), and ends the process. On the other hand, when the prev_ptr is included in the size table 429, the realloc_hook acquires the size corresponding to the prev_ptr and sets the acquired size as the prev_size (Step S96).

Then the realloc_hook performs a realloc process (Step S97). That is, the realloc_hook calls the realloc_org(prev_ptr, size) and sets a call result in the ptr.

The realloc_hook determines whether the ptr is not NULL (Step S98). When the ptr is NULL, then the realloc_hook ends the process, and when the ptr is not NULL, memory re-allocation is performed, and therefore the realloc_hook performs the totalization process (Step S99). Specifically, the realloc_hook performs, as the totalization process, addition and subtraction of memory usage, update of the maximum and the minimum of memory usages, and increment of the realloc call count.

The realloc_hook then updates the size table 429 (Step S100), and ends the process.

In this way, the realloc_hook hooks the call of the realloc and performs the totalization process of the memory usage, and the memory-usage totalizing device 20 can thereby totalize the memory usage on-line.

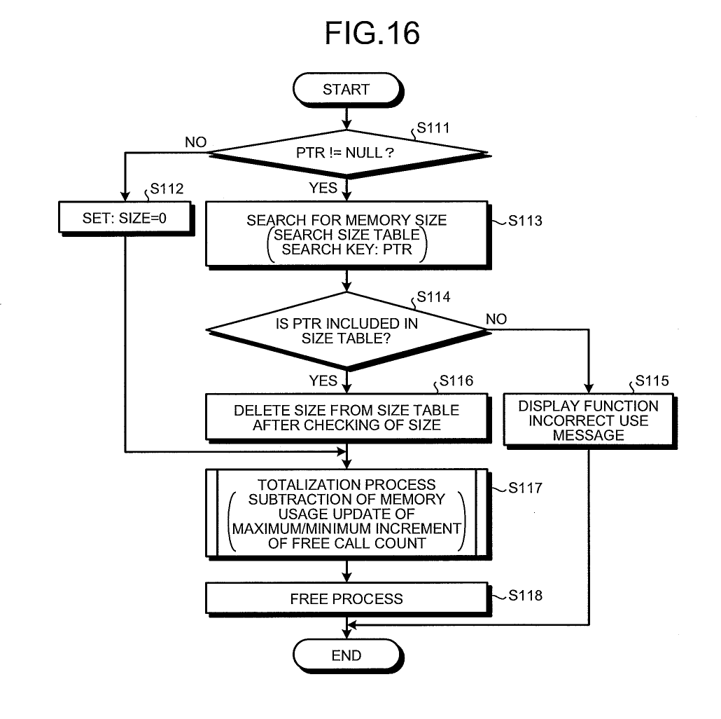

FIG. 16 is a flowchart of a procedure of the free_hook. As illustrated in FIG. 16, the free_hook first checks whether the argument ptr is not NULL (Step S111). When it is NULL, then at Step S112, the free_hook gives “0” to the size, and jumps to the totalization process (Step S117). When the ptr is not NULL, the free_hook searches for a memory size of the free area (Step S113). That is, the free_hook searches the size table 429 using the ptr as a search key.

Then the free_hook determines whether the ptr is included in the size table 429 (Step S114). When the ptr is not included therein, the argument is not correctly specified, and therefore the free_hook displays a function incorrect use message (Step S115), and ends the process. On the other hand, when the ptr is included in the size table 429, the free_hook acquires the size corresponding to the ptr and then deletes the free area from the size table 429 (Step S116).

Thereafter, the free_hook performs a totalization process (Step S117). Specifically, the free_hook performs, as the totalization process, subtraction of memory usage, update of the maximum and the minimum of memory usages, and increment of the free call count. The free_hook then performs the free process (Step S118), and ends the process.

In this way, the free_hook hooks the call of the free and performs the totalization process of the memory usage, and the memory-usage totalizing device 20 can thereby totalize the memory usage on-line.

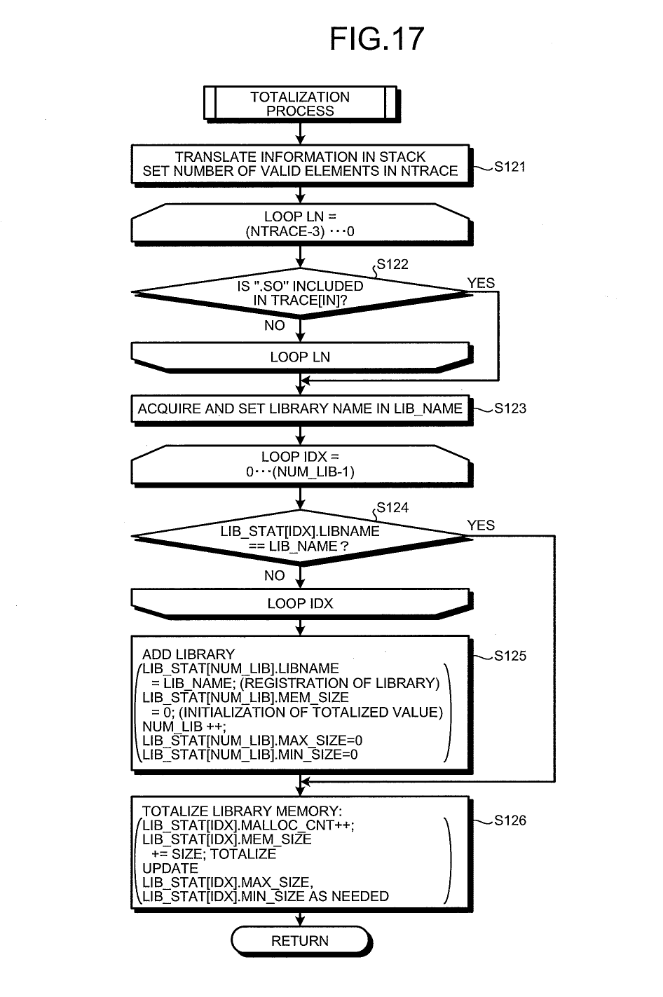

A procedure of the totalization process performed by the memory-usage totalizing unit 426 will be explained below. FIG. 17 is a flowchart of the procedure of the totalization process performed by the memory-usage totalizing unit 426. The totalization process illustrated in FIG. 17 corresponds to the processes at Step S84 of FIG. 14, at Step S100 of FIG. 15, and at Step S114 of FIG. 16.

As illustrated in FIG. 17, the memory-usage totalizing unit 426 traces back and translates the information in the stack, and sets the number of valid elements in ntrace (Step S121). The memory-usage totalizing unit 426 then determines whether “.so” is included in the trace[ln] (Step S122).

The memory-usage totalizing unit 426 sets a name of a retrieved library in lib_name (Step S123). That is, the memory-usage totalizing unit 426 identifies the dynamic library initially called from the main function by the processes at Step S122 and Step S123.

The memory-usage totalizing unit 426 then determines whether the name of the identified dynamic library has been registered in the lib_stat (Step S124). The lib_stat is a structure corresponding to the totalized-information storage unit 427, and the lib_stat[idx].libname indicates an idx-th library name stored in the totalized-information storage unit 427. That is, the memory-usage totalizing unit 426 sequentially changes the idx from 0 to num_lib−1, and determines whether the name of the identified dynamic library has been registered in the totalized-information storage unit 427. The num_lib is the number of libraries stored in the totalized-information storage unit 427.

When the name of the identified dynamic library has been registered in the lib_stat, the memory-usage totalizing unit 426 proceeds to Step S126, and adds the library when the name of the identified dynamic library has not been registered in the lib_stat (Step S125). Specifically, the memory-usage totalizing unit 426 registers the library name, as the library addition process, using the lib_stat[num_lib].libname=lib_name, initializes the totalized value to “0” using the lib_stat[num_lib].mem_size=0, and adds “1” to the num_lib using the num_lib++. In addition, the memory-usage totalizing unit 426 initializes the maximum value and the minimum value to “0” using the lib_stat[num_lib].max_size=0 and the lib_stat[num_lib].min_size=0 respectively.

The memory-usage totalizing unit 426 totalizes the memory amount used by the dynamic library (Step S126). Specifically, the memory-usage totalizing unit 426 adds “1” to the malloc call count, the malloc_cnt, using the lib_stat[idx].malloc_cnt++, and adds the allocated memory amount to the size, the mem_size, using the lib_stat[idx].mem_size+=size. In addition, the memory-usage totalizing unit 426 updates the lib_stat[idx].max_size and the lib_stat[idx].min_size as needed.

The case where the malloc system function is the malloc is represented herein. However, if the function is the realloc, the free, and the memalign, then “1” is added to the realloc call count, to the free call count, and to the memalign call count. If the identified function is the free, then the size is a value obtained by multiplying a freed amount by “−1”.

In this way, the memory-usage totalizing unit 426 totalizes the memory usage on-line, and the memory-usage totalizing device 20 can thereby totalize the memory usage without using the log file.

The memory-usage totalizing unit 426 totalizes the memory usage for each dynamic library herein; however, the memory-usage totalizing unit 426 identifies a called function name instead of the library name and registers the function name instead of the library name in the totalized-information storage unit 427, which enables the memory usage to be totalized for each function. In addition, the memory-usage totalizing unit 426 registers the thread ID instead of the library name in the totalized-information storage unit 427, which enables the memory usage to be totalized for each thread.

The memory-usage totalizing unit 426 sequentially changes ln from (ntrace-3) to 0 when the library is identified at Step S122. However, by sequentially changing ln from 0 to (ntrace-3), the memory-usage totalizing unit 426 can also identify the dynamic library that finally calls the malloc system function. In other words, the memory-usage totalizing unit 426 can also totalize the memory usage for each library that finally calls the malloc system function. Furthermore, the memory-usage totalizing unit 426 identifies a plurality of dynamic libraries for each call of one malloc system function, and can totalize memory usages for the dynamic libraries from the call of the main function to the call of the malloc system function.

As explained above, the second embodiment is configured that the memory-usage totalizing device 20 performs the classification and the totalization process of the memory usage on-line during execution of the measured program and displays a totalization result in response to the end of the measured program. Therefore, the memory-usage totalizing device 20 does not need to use the log file and can therefore save a disk storage area.

In the second embodiment, the memory-usage totalizing device 20 uses the atexit function to register a result display function and thereby outputs a totalization result when the measured program is ended. However, the memory-usage totalizing device 20 cannot output a totalization result when the program is terminated due to detection of various signals (abnormal end unexpected by the programmer). Therefore, a method of capable of outputting a totalization result upon termination of the program due to detection of various signals will be explained below.

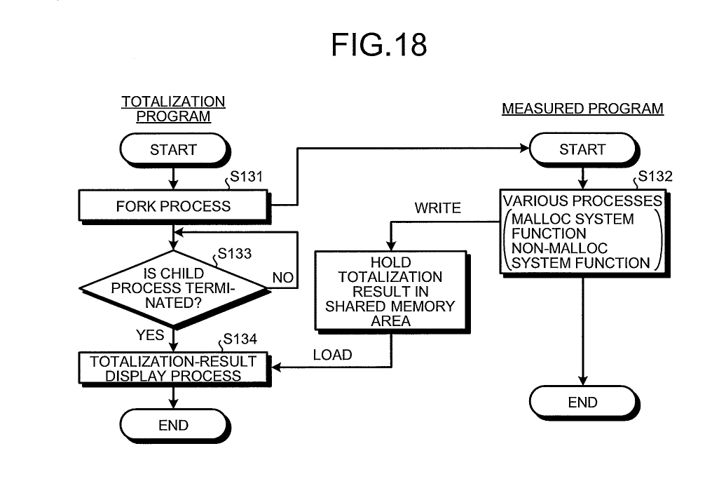

FIG. 18 is a diagram for explaining the method of capable of outputting a totalization result upon termination of the program due to detection of various signals. As illustrated in FIG. 18, a totalization program different from the measured program forks a process as a parent process (Step S131), and activates the measured program as a child process. The measured program writes the totalization result to a shared memory area while performing various processes (Step S132). The shared memory area then holds the totalization result.

The parent process checks whether the child process is terminated (Step S133), loads the totalization result of the shared memory area at the end of the child process, and performs a display process of the totalization result (Step S134). The parent process can also obtain totalized information using inter-process communication instead of the shared memory area.

Recently, a distributed memory parallel computer is used for the purpose of performing a computation process at a higher speed and for the purpose of concurrently performing data exceeding a memory amount of a single node. The distributed memory parallel computer is connected with a plurality of computers (computation nodes) through a high-speed network. The data processed between the computation nodes is communicated or shared as needed through the network. As a result, the distributed memory parallel computer performs huge data processing by performing processes at a high speed or storing different data at individual nodes as compared with a single computer.

The MPI is most widely used as system software for providing such a system as above. In the MPI, a process is started at each computation node using “mpiexec” command, and a parallel process is implemented by an arbitrary program as a child process of the process.

In an MPI program, processes operating at nodes need to operate in cooperation with each other, and “mpiexec” being the parent process forcefully terminates the child process (user program) executed by all the computation nodes when a process at one of the computation nodes is ended. This is an unexpected abnormal end in terms of the user program, and the MPI program is terminated without displaying the totalization result. Even if the method explained in FIG. 18 is used, the user program mentioned here corresponds to the parent process of FIG. 18 and the parent process is abnormally terminated, and therefore the totalization result is not displayed. In such a case, the software developers improve the “mpiexec” command and include the same system as that of FIG. 18 therein, so that the problem that the totalization result is not displayed can be solved.

In the first and the second embodiments, the memory-usage totalizing device has been explained; however, by implementing the configuration of the memory-usage totalizing device by software, it is possible to obtain a memory-usage totalizing program having the same function. Therefore, a computer that executes the memory-usage totalizing program is explained below.

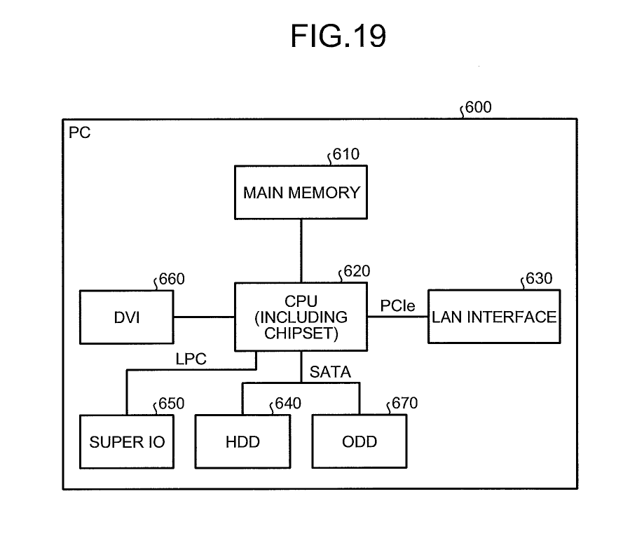

FIG. 19 is a functional block diagram of a computer that executes the memory-usage totalizing program according to the embodiments. As illustrated in FIG. 19, a computer 600 includes a main memory 610, a Central Processing Unit (CPU) 620, a Local Area Network (LAN) interface 630, a Hard Disk Drive (HDD) 640, and a super Input-Output (IO) 650. The computer 600 also includes a Digital Visual Interface (DVI) 660 and an Optical Disk Drive (ODD) 670.

The main memory 610 is a memory that stores therein programs and results during execution of the programs, and the like. The CPU 620 is a central processing unit that executes a program read from the main memory 610. The CPU 620 includes a chipset having a memory controller.

The LAN interface 630 is an interface for connecting the computer 600 to other computers through LAN. The HDD 640 is a disk drive that stores therein programs and data, and the super IO 650 is an interface for connecting an input device such as a mouse and a keyboard to the computer 600. The DVI 660 is an interface for connecting a liquid-crystal display device thereto, and the ODD 670 is a device that reads and writes data to DVD.

The LAN interface 630 is connected to the CPU 620 through Peripheral Component Interconnect (PCI) Express, and the HDD 640 and the ODD 670 are connected to the CPU 620 through Serial Advanced Technology Attachment (SATA). The super IO 650 is connected to the CPU 620 through Low Pin Count (LPC).

The memory-usage totalizing program executed on the computer 600 is stored on DVD, and is read out from the DVD by the ODD 670 to be installed into the computer 600. Alternatively, the memory-usage totalizing program is stored in a database or the like in other computer systems connected through the LAN interface 630, and is read out from the database to be installed into the computer 600. The installed memory-usage totalizing program is stored in the HDD 640, and is loaded to the main memory 610 to be executed by the CPU 620.

The first and the second embodiments have explained the case where the usages of the heap areas are totalized; however, the present invention is not limited thereto. Therefore, the present invention is also applicable to a case where the usages of other memory areas such as a stack area and of other hardware resources such as a nonvolatile storage device are totalized.

According to one aspect of the present invention, software developers can obtain useful information for reduction in usage of hardware resources.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-readable storage medium having stored therein a resource-usage totalizing program for causing a computer to execute a processing comprising:
totalizing, for a resource used when the computer executes a program, usage of the resource in units of processing smaller than a process being units of processing in which the computer executes the program; and
outputting the totalized usage of the resource in the units of processing smaller than the process.

2. The computer-readable storage medium according to claim 1, wherein the totalizing includes
hooking a call of an allocation function for requesting allocation of the resource by executing an allocation hook function that performs a processing required for the totalization and calls the allocation function, and
hooking a call of a free function for requesting free of the resource by executing a free hook function that performs a processing required for the totalization and calls the free function.

3. The computer-readable storage medium according to claim 2, wherein the totalizing includes
executing the program and outputting information required for the totalization by the allocation hook function and the free hook function as log information, and
totalizing the usage of the resource using the log information after the execution of the program.

4. The computer-readable storage medium according to claim 2, wherein the totalizing includes
totalizing the usage of the resource by the allocation hook function and the free hook function during the execution of the program.

5. The computer-readable storage medium according to claim 1, wherein
the units of processing are a dynamic library, a function included in a dynamic library or a thread included in a dynamic library.

6. The computer-readable storage medium according to claim 1, wherein
the units of processing are either one of each call of a dynamic library and each call of a function included in a dynamic library.

7. The computer-readable storage medium according to claim 1, wherein the totalizing includes
dividing an execution time of the program at a predetermined time interval, and
totalizing the usage of the resource at each time interval.

8. A resource-usage totalizing method executed by a computer, the resource-usage totalizing method comprising:
totalizing, using a processor for a resource used when the computer executes a program, usage of the resource in units of processing smaller than a process being units of processing in which the computer executes the program; and
outputting the totalized usage of the resource in the units of processing smaller than the process.

9. A resource-usage totalizing device comprising:
a totalizing unit that totalizes, for a resource used when a program is executed, usage of the resource in units of processing smaller than a process being units of processing in which the program is executed; and
an output unit that outputs the usage of the resource totalized by the totalizing unit in the units of processing smaller than the process.
